(19) United States
(12) Patent Application Publication
(10) Pub. No.: US 2014/0237528 A1
(43) Pub. Date: Aug. 21, 2014

(54) APPARATUS AND METHOD FOR USE WITH A DATA STREAM

(71) Applicants: Jan Erik Lindquist, Älvsjö (SE); Ola Andersson, Sao Paolo (BR)

(72) Inventors: Jan Erik Lindquist, Älvsjö (SE); Ola Andersson, Sao Paolo (BR)

(73) Assignee: Telefonaktiebolaget L M Ericsson (PUBL), Stockholm (SE)

(21) Appl. No.: 14/347,953

(22) PCT Filed: Sep. 27, 2011
(86) PCT No.: PCT/EP2011/066796

§ 371 Date: Mar. 27, 2014

(51) Int. Cl. H04N 21/438

(52) U.S. Cl. CPC H04N 21/438
USPC 725/109

(57) ABSTRACT

Telecommunications Network and Method An apparatus (201) comprises an interface (205) for receiving a data stream (203), for example a digital media data stream such as MPEG2-TS. The data stream (203) comprises a set of component parts (for example video, audio, subtitle), wherein one or more of the component parts further comprises a set of sub-component parts (for example a plurality of video, audio or subtitle sub-component parts, respectively). A filter unit (213) is adapted to filter the received data stream, such that a set of sub-component parts associated with a particular component part is filtered into a first sub-component part (221) and a second sub-component part (222), wherein the first sub-component part (221) is output to a first device (for example a TV, not shown), and the second sub-component part (222) is output to a second device (for example a tablet device, not shown).

### TECHNICAL FIELD

The invention relates to an apparatus and method for use with a data stream, for example a digital media data stream such as a broadcast television signal, and in particular to an apparatus and method for playback of portions of a data stream on first and second devices.

### BACKGROUND

It has become popular to use a second display device while watching television, for example whereby an end user not only enjoys watching television, but also has a laptop or tablet device for watching digital media via the internet. In this way an end user is able to view a main program on a television (using a broadcast signal received at the television), and watch an auxiliary scene relating to the main program on a tablet device.

FIG. 1 shows an example of a data stream 103, such as an MPEG2-TS signal. When conveyed over a MPEG2-TS signal 103, a “stream” of data can be used to convey various components, for example a video component 105, an audio component 107 or a subtitle component 109. The components may relate to a program 111.

The video component 105 may comprise information such as MPEG Program Identifier (PID) information, component types, encoding format, encryption indication or aspect ratio (if known).

The audio component 107 may comprise information such as MPEG Program Identifier (PID) information, component types, encoding format, encryption indication, language (ISO 639), audio description (caption) or audio channels (for example stereo, 5.1).

The subtitle component 109 may comprise information such as MPEG Program Identifier (PID) information, component types, encoding format, encryption indication, language (ISO 639) or hearing impaired indications.

Each component may in turn comprise multiple sub-components, for example multiple video sub-components, multiple audio sub-components and multiple subtitle sub-components.

While it may be appreciated why audio and subtitle components have multiple sub-components, the need for a plurality of video sub-components may not be as evident. It is therefore noted that a video component may include multiple video sub-components in order to provide different angles of the same scene. For example, in a soccer match it is possible to have one video sub-component showing the ball play while a second video sub-component follows a specific player, such as the favourite player of the end user.

In a home network the relationship between a television apparatus and a tablet device can be restricted by standards provided by the Digital Living Network Affiance (DLNA), for example, or by proprietary solutions. DLNA is an industry-wide standard for sharing data on a home network, whereby a TV and tablet device can share data using a home network router.

With DLNA it is possible to view media (for example pictures, audio and video) on the TV. The TV has the option to support a rendering device where the control is carried out through a tablet. In this scenario the TV is a Digital Media Renderer (DMR) and the tablet is a Digital Media Controller (DMC). The location where the content is retrieved from is known as a Digital Media Server (DMS). The location of the DMS can be in the tablet, a Network Attached Storage (NAS) device, or a personal computer located in the home.

The TV can also be simply a presenter without the need for a digital media controller. In such a scenario, a TV may search for content in the home through

DLNA Content Directory Services and present the content. The TV is then termed a Digital Media Presenter (DMP).

There are proprietary solutions that are being offered by some TV vendors, whereby the content on the TV can be streamed to a tablet device. In such an application the programs that terminate in the TV can be streamed to a tablet device.

Another known solution is to have a TV which receives one stream, for example from a satellite or cable receiver, while a tablet device receives another stream from the internet. This solution has the disadvantage of using IP resources, and also suffers from synchronisation problems whereby the stream being used on the TV is out of synchronisation with a stream used on the tablet device. As will be appreciated, this lack of synchronisation is problematic when viewing content such as soccer matches.

### SUMMARY

It is an aim of the present invention to provide an apparatus and method that do not suffer, or help alleviate, one or more of the disadvantages mentioned above.

According to a first aspect of the invention, there is provided an apparatus comprising an interface for receiving a data stream comprising a set of component parts, wherein one or more of the component parts further comprises a set of sub-component parts. The apparatus also comprises a filter unit adapted to filter the received data stream, such that a set of sub-component parts associated with a particular component part is filtered into a first sub-component part and a second sub-component part, wherein the first sub-component part is output to a first device, and the second sub-component part is output to a second device.

According to another aspect of the present invention, there is provided an apparatus for receiving a broadcast television signal comprising at least video, audio or subtitle component parts, wherein a video, audio or subtitle component part further comprises video, audio or subtitle sub-component parts, respectively, wherein the apparatus is adapted to partition the sub-components parts of the video, audio or subtitle components such that they can be transmitted to different audiovisual devices simultaneously.

According to another aspect of the invention, there is provided a method comprising the steps of receiving a data stream comprising a set of component parts, wherein one or more of the component parts further comprises a set of sub-component parts. A set of sub-component parts associated with a particular component part are filtered into first and second sub-component parts. The first sub-component part is output to a first device, and the second sub-component part output to a second device.

### BRIEF DESCRIPTION OF THE DRAWINGS

For a better understanding of the present invention, and to show more clearly how it may be carried into effect, reference will now be made, by way of example only, to the following drawings in which:

FIG. 1 shows an example of a digital media stream, such as an MPEG2-TS stream;

FIG. 2 shows an apparatus according to an embodiment of the present invention;

FIG. 3 shows how a digital media stream may be adapted according to embodiments of the present invention;

FIG. 4 shows an example of a system employing an apparatus as shown in FIG. 2;

FIG. 5 shows further details of the system of FIG. 4 when used in an example application; and

FIG. 6 shows a method according to an embodiment of the invention.

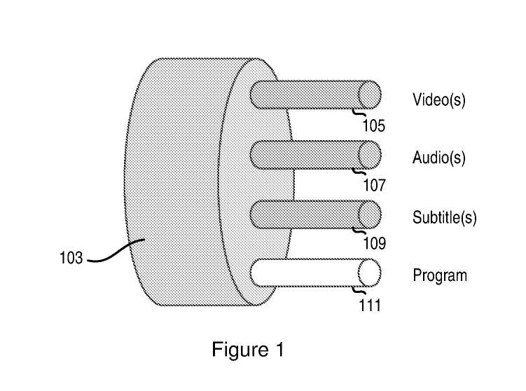

### DETAILED DESCRIPTION

The embodiments of the invention, as described below, refer to a data stream comprising a MPEG2-TS data stream. It is noted, however, than the embodiments of the invention are applicable to any data stream, including any digital media data stream.

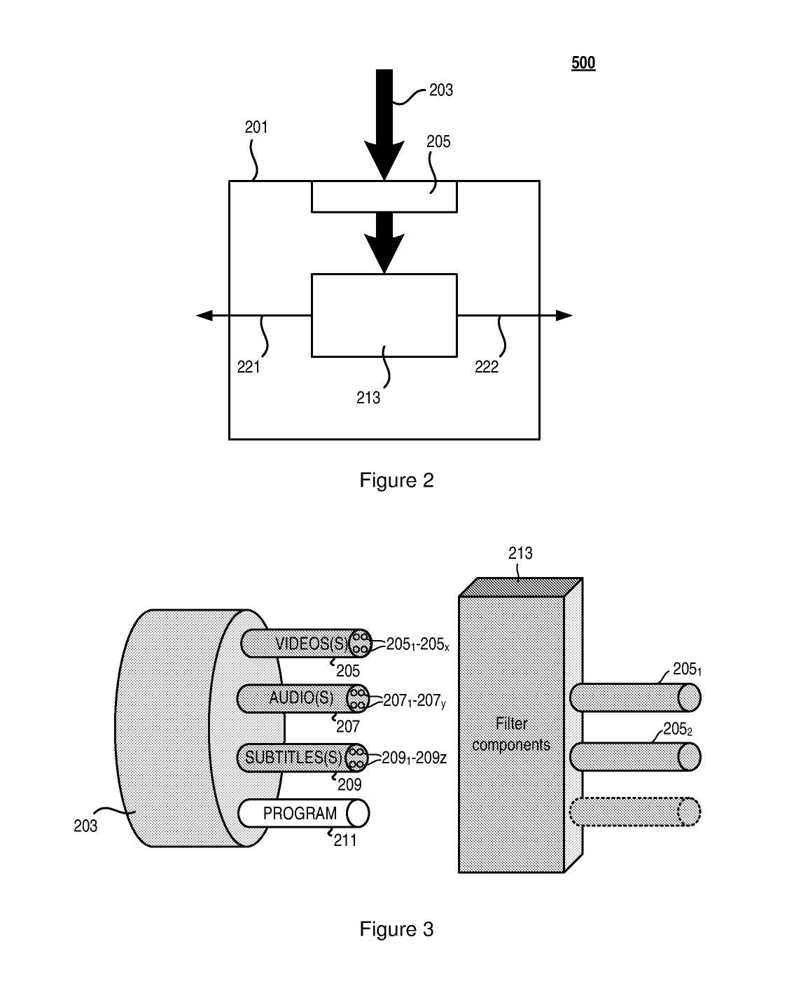

Referring to FIG. 2, according to an embodiment of the invention, an apparatus 201 comprises an interface 205 for receiving a data stream 203 such as MPEG2-TS. The data stream 203 comprises a set of component parts (for example video, audio, subtitle), wherein one or more of the component parts further comprises a set of sub-component parts (for example a plurality of video, audio or subtitle sub-component parts, respectively). A filter unit 213 is adapted to filter the received data stream, such that a set of sub-component parts associated with a particular component part is filtered into a first sub-component part 221 and a second sub-component part 222, wherein the first sub-component part 221 is output to a first device (for example a TV, not shown), and the second sub-component part 222 is output to a second device (for example a tablet device, not shown).

It is noted that although the embodiment above refers to a set of sub-component parts being filtered into first and second sub-component parts for output to first and second devices, the set of sub-component parts may be filtered into any number of sub-component parts, for output to any number of devices. In addition, it will be appreciated that a sub-component part may be subject to further processing on route to a respective device.

FIG. 3 illustrates in further detail an example of the component parts and the sub-component parts for use with the embodiment of FIG. 2. The data stream 203, for example a MPEG2-TS data stream, comprises a set of component parts, for example a video component part 205, an audio component part 207 and a subtitle component part 209. The component parts, 205, 207, 209 may be associated with a program 211, for example a broadcast program received from a satellite, terrestrial or cable source). The broadcast signal may also be received from an IP source such as the internet. Each of the component parts 205, 207, 209 comprises a set of sub-component parts. For example, the video component part 205 may comprise a set of video sub-component parts 205₁-205ₓ, the audio component part 207 a set of audio sub-component parts 207₁-207_{y}, and the subtitle component part a set of subtitle sub-component parts 209₁-209_{z}. It is noted that different component parts may have the same or a different number of sub-component parts without departing from the scope of the invention. It is also noted that one or more of the component parts need not necessarily comprise a plurality of sub-component parts.

The filter unit 213 of FIG. 3 is adapted, as mentioned above, to filter the received data stream 203, such that a set of sub-component parts, for example 205₁-205ₓ, associated with a respective component part 205, is filtered into a first sub-component part 205₁ and a second sub-component part 205₂, such that the first sub-component part 205₁(a first video signal) is output to a first device (such as a TV, not shown), and the second sub-component part 205₂ (a second video signal) is output to a second device (for example a tablet device, not shown). In this manner the apparatus enables a TV to display a first video signal and a tablet device a second video signal. For example, the TV can display a first video relating to the main viewing content of a soccer match (e.g. the ball play), while a tablet device displays a second video relating to another scene, for example a favourite player, or vice versa.

It is noted that the filter may be adapted to filter the sub-component parts of more than one component part simultaneously, or in parallel, such that any combination of video, audio, subtitle and/or other component part is directed to any combination of devices.

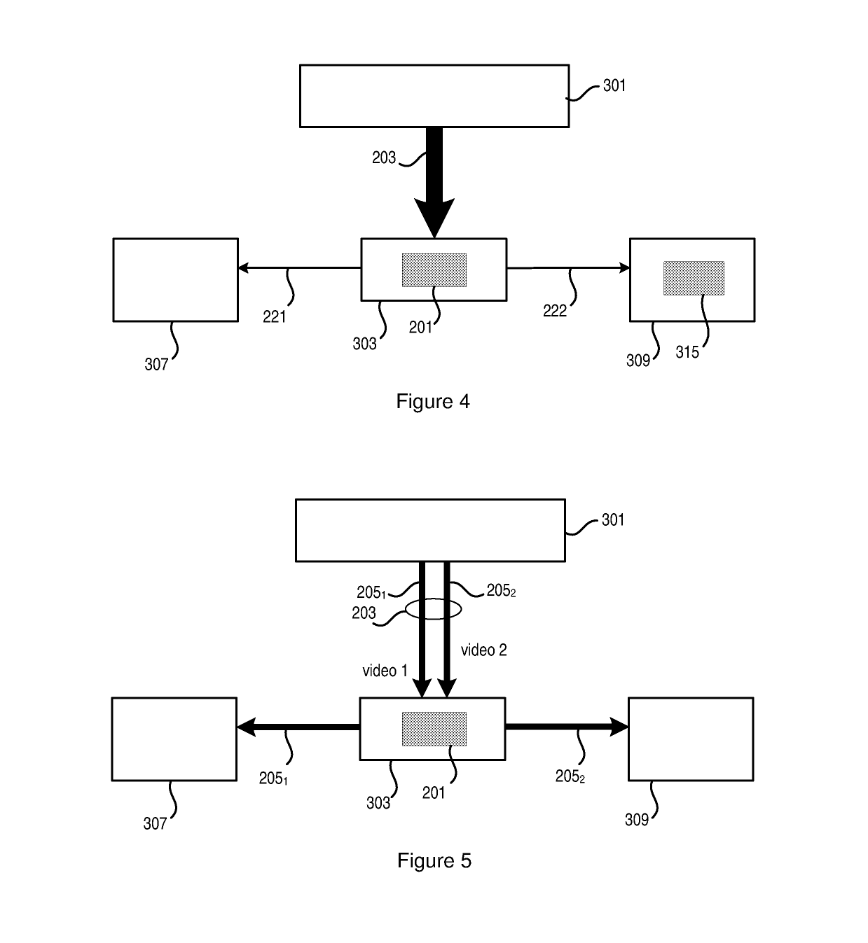

FIG. 4 shows an example of a system in which the embodiments of the invention may be used. The system of FIG. 4 relates to filtering a data stream 203 received from a broadcaster 301 (for example a digital video broadcast signal such as DVB-S or DVB-T). A filter apparatus 201 is shown as forming part of a Set-Top-Box (STB) 303. it is noted that the filter apparatus 201 is not limited to being provided in a STB 303, but may be provided as a stand-alone device, or part of another device. The filter apparatus 201 filters the received broadcast signal, which may comprise a set of component parts such as video, audio and subtitle component parts, as described above, such that a set of sub-component parts relating to the original set of components from MPEG2-TS is filtered out to a first sub-component part 221 that is sent to a first device (for example a TV in the home), while a second sub-component part 222 is sent to a second device (for example a tablet device 309 in the home). A processing function 315 may be provided in the second device 309, for example an “application” such as an Android Marketplace Application™. The processing function 315 can facilitate communication with STB 303, to control the filtering to be performed by the filter apparatus 201. The processing function 315 (e.g. “App”) may be customized for this support. It can be considered as half proprietary since it will use DLNA according to a standard but will communicate to the STB terminal 303 to set the filtering which may be by means that are not proprietary. Alternatively, a HTTPrest interface may be used instead.

FIG. 5 shows further details of the system of FIG. 4 when used in a typical application, and illustrates the sequence of events. A received data stream 203, such as a MPEG2-TS data stream from a broadcaster 301 is terminated in a STB 303. The received data stream 203 comprises at least a first video sub-component 205₁ and a second video sub-component 205₂. The first and second video sub-components 205₁, 205₂ may relate to the same program. The STB 303 comprises a filter apparatus 201 according to an embodiment of the invention. The filter apparatus 201 is adapted to filter the received data stream 203, such that a main video sub-component 205₁ is presented on a TV 307, while the second video sub-component 205₂ is filtered out for presenting to a tablet device 309. The filter may be adapted to filter audio, subtitle and/or other component parts, in addition, or as an alternative to the video signals.

The delivery of the sub-component parts may be carried out in a wireless manner, for example using DLNA mechanisms or proprietary mechanisms, or via hard wired connections.

Although the embodiments of FIGS. 4 and 5 illustrate the filter apparatus being provided in a STB 303, it is noted that the filter apparatus 201 may be provided as a separate entity in its own right, or form part of another device, such as part of a TV or tablet device that is coupled to receive an incoming data stream having component parts.

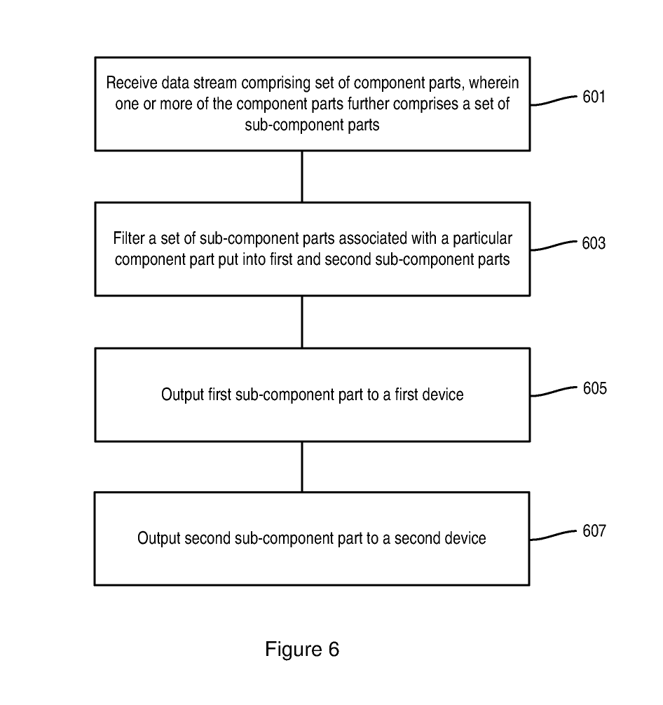

FIG. 6 shows the steps performed by an embodiment of the invention. In step 601 a data stream is received, the data stream comprising a set of component parts, wherein one or more of the component parts further comprises a set of sub-component parts. In step 603 a set of sub-component parts associated with a particular component part is filtered out into a first sub-component part and a second sub-component part. A first sub-component part is output to a first device, step 605, and a second sub-component part is output to a second device, step 607. The steps 605 and 607 may be performed simultaneously or in parallel.

The ability to filter allows different services to be provided. For example, if a MPEG2-TS data stream contains multiple audio and subtitle components. The TV may display one audio language while the Table may receive a different audio language or even different subtitle.

The filter apparatus may be controlled in a number of ways. According to one embodiment, the filter apparatus may be controlled in a STB, for example using a controller (such as a remote control device) normally used to control the STB.

According to another embodiment, the filter apparatus may be controlled in a TV, for example using a controller (such as a remote control device) normally used to control the TV.

According to another embodiment, the filter apparatus may be located in one device (for example a STB), and controlled using a remote control device associated with another device (for example a TV).

According to another embodiment, the filter apparatus is controlled according to information received in the data stream, or according to how the received data stream is formatted. For example, the received data stream may comprise a standardization format that is adapted to enable a filter apparatus to filter sub-component parts of a component part into first and second sub-component parts. The data stream may be formatted to provide Open IPTV Forum (OIPF) or Declarative Application Environment (DAE) specifications. According to such an embodiment, a new function is introduced in the Open Internet protocol

Television Terminal Function (OITF) that can expose a broadcast stream to other devices in the home, such as a tablet. The new function may be a filtering function, whereby a broadcast signal received in a home location can be automatically adapted based on the configuration of the home network, such that different sub-components are diverted to different home components as they are received by the filter apparatus. In this way, the available components in the received data stream are “exposed”, then one or more component and/or sub-components are selected or filtered. The result will be the basis for what is forwarded. The component may include information such as a “description”, for example a PID number, which is provided to help a lower layer to determine what should be filtered or not.

The filter function has the responsibility to identify a source (for example a broadcast channel) for filtering. Once the source is identified, the source is made available for local transmission to the home network. The transmission may be based, for example, on HTTP Adaptive Streaming or HTTP Streaming using universal plug and play Audio/Video transport control. The control of the HTTP streaming will be familiar to a person skilled in the art.

The filtering function according to this embodiment has the ability to control which components to be exposed as output. This has the advantage that unwanted outputs can be ignored by simply removing components, which is easier than attempting to transcode video formats from high definition quality video to a lower resolution. Components that are not of interest for display may be removed from a table containing a list of component parts, thus saving home network resources. Alternatively the content may be split into different HTTP Adaptive Streaming quality. This may require transcoding. Transcoding may be required if the format of the video needs to be adapted. For example, high resolution HD quality data may be being processed, but in order to stream the data adaptively, it may require conversion to a lower quality. This transformation to a lower quality requires decrypting the stream and re-encoding in a lower quality such as SD before it is ready for transmission to a remote device, such as a remote tablet.

The embodiments of the invention described above have the advantage of not requiring network resources to be used for delivering additional material through the usage of MPEG2-TS to deliver the whole bundle

A second device, such as a second screen, is not affected and does not need to be aware that it is part of the solution. Instead, it simply needs to reuse DLNA services.

The customization of the type of services that would use this functionality are easily achieved if using web technology, such as the “APPs” as described above, although these are not necessarily required. If adopted, such Apps can use web technology or HTTPrest.

The embodiments described above have the advantage of being able to stream content to multiple devices in the home (for example a TV and tablet), and can avoid using network IP resources. The embodiments of the invention also have the advantage of being able to synchronise the experience between what is presented on the TV and that of the tablet, with minimal network resources usage.

The synchronisation provided by the embodiments relate to presenting on both the TV and the tablet content related to the same program.

The embodiments also have the advantage of avoiding the need to handle two streams at the same time, one stream to the TV and another stream to the tablet via the internet. As such, the embodiments of the invention have the advantage in that there is no requirement to have two streams into the home, but only 1, with communication within the home being optimized with a smaller stream.

It is noted that the embodiments of the invention can use any form of format to stream data between the filtering unit and the first and second devices, including DLNA or frameworks such as Apple's Bonjour™ framework for streaming. In such scenarios the formatting/filtering available over DLNA/Bonjour is controlled in a master terminal.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. An apparatus comprising:
an interface for receiving a data stream comprising a set of component parts, wherein one or more of the component parts further comprises a set of sub-component parts; and
a filter unit adapted to filter the received data stream, such that a set of sub-component parts associated with a particular component part is filtered into a first sub-component part and a second sub-component part, wherein the first sub-component part is output to a first device, and the second sub-component part is output to a second device.

2. An apparatus as claimed in claim 1, wherein a component part comprises a video signal having a plurality of sub-component parts relating to different video signals, and wherein the first interface is adapted for outputting a first video signal to a first display device, and wherein the second interface is adapted to output a second video signal to a second display device.

3. An apparatus as claimed in claim 1, wherein a component part comprises an audio signal having a plurality of sub-component parts relating to different audio signals, and wherein the first interface is adapted for outputting a first audio signal to a first audio playback device, and wherein the second interface is adapted to output a second audio signal to a second audio playback device.

4. An apparatus as claimed in claim 1, wherein a component part comprises a subtitle signal having a plurality of sub-component parts relating to different subtitle signals, and wherein the first interface is adapted for outputting the first subtitle signal to a first display device, and wherein the second interface is adapted to output a second subtitle signal to a second display device.

5. An apparatus as claimed in claim 2, wherein one or more of the video signal, audio signal and subtitle signal relate to the same program.

6. An apparatus as claimed in claim 1, wherein the processing unit is coupled to receive a control signal for controlling the filtering operation.

7. An apparatus as claimed in claim 6, wherein the control signal is received with the data stream.

8. An apparatus as claimed in claim 6, wherein the control signal is received from a peripheral device associated with the apparatus.

9. An apparatus for receiving a broadcast television signal comprising at least video, audio or subtitle component parts, wherein a video, audio or subtitle component part further comprises video, audio or subtitle sub-component parts, respectively, wherein the apparatus is adapted to partition the sub-components parts of the video, audio or subtitle components such that they can be transmitted to different audiovisual devices simultaneously.

10. A television apparatus, set top box or mobile communication apparatus comprising an apparatus as claimed in claim 1.

11. A method comprising the steps of:
receiving a data stream comprising a set of component parts, wherein one or more of the component parts further comprises a set of sub-component parts;
filtering a set of sub-component parts associated with a particular component part into first and second sub-component parts;
outputting the first sub-component part to a first device; and
outputting the second sub-component part to a second device.

12. A method as claimed in claim 11, wherein a component part comprises a video signal having a plurality of sub-component parts relating to different video signals, and wherein the method comprises the steps of outputting a first video signal to a first display device, and outputting a second video signal to a second display device.

13. A method as claimed in claim 11, wherein a component part comprises an audio signal having a plurality of sub-component parts relating to different audio signals, and wherein the method comprises the steps of outputting a first audio signal to a first audio playback device, and outputting a second audio signal to a second audio playback device.

14. A method as claimed in claim 11, wherein a component part comprises a subtitle signal having a plurality of sub-component parts relating to different subtitle signals, and wherein the method comprises the steps of outputting the first subtitle signal to a first display device, and outputting a second subtitle signal to a second display device.

15. A method as claimed in claim 11, further comprising the step of receiving a control signal, and adapting the filtering step according to the received control signal.

16. A method as claimed in claim 15, wherein the control signal is received with the data stream from a peripheral device.
